(19) United States
(12) Patent Application Publication
(10) Pub. No.: US 2026/0054253 A1
(43) Pub. Date: Feb. 26, 2026

(54) Cerium- and Zirconium-Based Mixed Oxide

(71) Applicant: Rhodia Operation, Lyon (FR)

(72) Inventors: Simon Ifrah, La Rochelle (FR); Rui Miguel Jorge Coelho Marques, Lyon (FR); Ling Zhu, Jiangsu (CN); Delong Xu, Jiangsu (CN); Julien Hernandez, Aubervilliers (FR)

(21) Appl. No.: 19/102,901

(22) PCT Filed: Aug. 11, 2023
(86) PCT No.: PCT/EP2023/072268

§ 371 Date: Feb. 11, 2025

(30) Foreign Application Priority Data
Aug. 12, 2022 (WO) PCT/CN2022/111999

(51) Int. Cl. B01J 23/10; B01D 53/94; B01J 37/00; B01J 37/04; B01J 37/06; B01J 37/08

(52) U.S. Cl. CPC B01J 23/10; B01D 53/94; B01J 37/009; B01J 37/04; B01J 37/06; B01J 37/08

(57) ABSTRACT

The present invention relates to a mixed oxide of zirconium, of cerium, of lanthanum and optionally of at least one rare earth metal other than cerium and lanthanum (REM), characterized by BET specific surfaces, a specific range of pores and the process for preparing such a mixed oxide.

### CROSS-REFERENCE TO RELATED APPLICATIONS

This application is the United States national phase of International Patent Application No. PCT/EP2023/072268 filed Aug. 11, 2023, and claims priority to International Patent Application No. PCT/CN2022/111999 filed Aug. 12, 2022, the disclosures of which are hereby incorporated by reference in their entireties.

### BACKGROUND OF THE INVENTION

### Field of the Invention

The present invention relates to a mixed oxide of zirconium, cerium, lanthanum and optionally at least one oxide of a rare earth metal other than cerium and lanthanum exhibiting a high porosity and a high specific surface area, to its process of preparation and to its use in catalysis.

### Description of Related Art

“Multifunctional” catalysts are currently used for the treatment of exhaust gases from internal combustion engines (motor vehicle afterburning catalysis). Multifunctional is understood to mean catalysts capable of carrying out not only oxidation, in particular of carbon monoxide and hydrocarbons present in exhaust gases, but also reduction, in particular of nitrogen oxides also present in these gases (“three-way” catalysts).

The catalyst results from the interaction of a precious metal (for example Pd, Pt, Rh) with a mixed oxide based on cerium and on zirconium, often as a mixture with alumina. The mixed oxide has to exhibit a suitable porosity. Thus, it has to exhibit a pore volume that is sufficiently large and also to comprise pores with a size sufficiently large to make possible good diffusion of the gases. The mixed oxide also has to exhibit a specific surface area sufficiently large to be usable in catalysis.

It is known that small-sized pores develop the most specific surface area. In fact it is these pores which are the most sensitive to sintering. It is thus advantageous to develop a mixed oxide exhibiting a good compromise between a large pore volume, a high surface area, even after maintaining at a high temperature, and for which there exists a population of small-sized pores that exhibits a good thermal resistance.

The mixed oxide according to the invention as described herein is targeted at such a compromise.

### SUMMARY OF THE INVENTION

The present invention deals with a mixed oxide of zirconium, cerium, lanthanum and optionally of at least one rare earth metal (REM) other than cerium and lanthanum, the proportions by weight of these elements, expressed as oxide equivalent, with respect to the total weight of the mixed oxide being as follows:
between 8% and 47% of cerium;
between 1% and 10% of lanthanum;
between 0% and 15% of the rare earth metal other than cerium and lanthanum;
the remainder as zirconium,
characterized in that the mixed oxide exhibits:
   a BET specific surface area of at least 30 m²/g after calcination at a temperature of 1100° C. for 4 hours;
   a BET specific surface area of at least 50 m²/g after calcination at a temperature of 1000° C. for 4 hours;
   a derivative curve (dV/d log D) obtained by mercury porosimetry on the mixed oxide after calcination at a temperature of 1100° C. for 4 hours exhibiting, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter and
   a ratio R comprised between 0.50 and 0.60, R being defined by:

$$R = V 1 / V 2$$

wherein:
   V1 is the pore volume developed by the pores for which the diameter in nm is between (Dp,1100° C./4 h−15) and (Dp,1100° C./4 h+15);
   V2 is the pore volume developed by the pores for which the diameter is less than or equal to 200 nm;
   V1 and V2 being determined by mercury porosimetry on the mixed oxide after calcination at 1100° C. for 4 h.

In another aspect, the mixed oxide also comprises hafnium.

As such, and in a further aspect of the invention, the mixed oxide is characterized in that the proportion by weight of hafnium in the mixed oxide is less than or equal to 2.5%, indeed even less than or equal to 2.0%, expressed as oxide equivalent with respect to the total weight of the mixed oxide.

According to another aspect, the mixed oxide of the invention is characterized in that the elements Ce, La, Rare Earth Metal (REM) other than cerium and lanthanum, Zr and Hf are present in the form of oxide, of hydroxide or of oxyhydroxide, more particularly in the form of oxide.

In a still further aspect, the mixed oxide of the invention is characterized in that the REM other than cerium and lanthanum is chosen from yttrium, neodymium or praseodymium or any combination thereof.

In a specific aspect of the invention, the mixed oxide comprises only yttrium as rare earth metal other than cerium and lanthanum.

In a specific aspect of the invention, the mixed oxide comprises only two rare earth metals other than cerium and lanthanum, which may be yttrium and neodymium or yttrium and praseodymium.

In another aspect, the mixed oxide consists essentially of a mixture of oxides of zirconium, of cerium, of lanthanum, optionally of at least one REM other than cerium and lanthanum and optionally of hafnium.

In another aspect, the mixed oxide of the invention does not comprises any rare earth metal other than cerium and lanthanum.

In specific aspects of the invention, the mixed oxide as claimed in one of claims consists essentially of the following elements:
zirconium, cerium, lanthanum, yttrium and optionally hafnium;
zirconium, cerium, lanthanum, yttrium, neodymium and optionally hafnium; or
zirconium, cerium, lanthanum, yttrium, praseodymium and optionally hafnium;
zirconium, cerium, lanthanum, neodymium, praseodymium and optionally hafnium or
zirconium cerium, lanthanum and optionally hafnium.

In a further aspect, the mixed oxide of the invention is characterized by the proportion by weight of the zirconium, expressed as oxide equivalent, comprised between 40 and 91.0%, preferably between 44.0 and 80.0%, more preferably between 44.0 and 76.0%.

In a still further aspect, the mixed oxide of the invention has a tapped density equal to or greater than 0.4 g/cm³, preferably equal to or greater than 0.5 g/cm³.

In a more specific aspect, the tapped density of the mixed oxide is from 0.5 g/cm3 to 0.9 g/cm³.

In a further aspect, the mixed oxide of the invention is characterized in that the derivative curve (dV/d log D) obtained by mercury porosimetry on the mixed oxide after calcination at a temperature of 900° C. for 4 hours exhibits, in the range of the pores with a diameter of less than or equal to 200 nm, one peak for which the maximum corresponds to a pore diameter denoted Dp,900° C./4 h and such that the difference in absolute value (Dp,1100° C./4 h)−(Dp, 900° C./4 h) is less than or equal to 15 nm, preferably less than or equal to 12, indeed even less than or equal to 11 nm.

In a further aspect, the mixed oxide of the invention is characterized by a pore volume (V2) of 0.20 to 0.50 ml/g, in particular of 0.24 to 0.41 ml/g.

In a still further aspect, the mixed oxide of the invention which is provided in the form of a powder, has a mean diameter d50 determined by laser diffraction over a distribution by volume is comprised between 1.0 and 30.0 m preferably between 2.0 and 20.0 m even more preferably between 3.0 and 10.0 m.

In a more specific aspect, the mixed oxide of the invention is characterized in that the derivative curve (dV/d log D), obtained by mercury porosimetry on the mixed oxide after calcination at a temperature of 900° C. for 4 hours, does not exhibit two distinct peaks

The present invention also deals with a process for the preparation of the mixed oxide as described above, comprising the following steps:
(a1) an aqueous solution of cerium nitrate and of zirconium nitrate is introduced into a stirred vessel containing a basic aqueous solution;
(a2) optionally an aqueous solution of nitrate of the rare earth metal (REM) other than cerium and lanthanum is subsequently introduced into the mixture formed in step (a1), and kept stirred;
(a2′) optionally the mixture obtained at the end of step (a1) or (a2) is heated at a temperature comprised between 5° and 95° C.;
(a3) an aqueous solution of lanthanum nitrate is subsequently introduced into the mixture formed in step (a2), (a2′) or (a1), and kept stirred;
(a4) the mixture obtained at the end of step (a3) is heated with stirring;
(a5) a templating agent is subsequently introduced into the mixture obtained in the preceding step;
(a6) optionally, the mixture is filtered and the precipitate is washed;
(a7) the precipitate obtained at the end of step (a6) is calcined at a temperature of between 700° C. and 1100° C.; and
(a8) the mixed oxide obtained in step (a7) is optionally ground.

In a specific aspect, of the process above, the concentration of mixed oxide of the aqueous solution after step (a3) is from 30 g/l to 80 g/l expressed as metal oxides.

The present invention also deals with a mixed oxide obtained by the process above described.

The invention deals additionally with a composition comprising the mixed oxide and a mixture with at least one mineral material.

In a specific aspect, the mineral material of the composition of the invention is chosen from alumina, titanium oxide, cerium oxide, zirconium oxide, silica, spinels, zeolites, silicates, crystalline silicoaluminum phosphates or crystalline aluminum phosphates.

The invention deals with a catalytically active coating layer, deposited at the surface area of a solid support, comprising the mixed oxide as described above or a composition as described above.

The invention also deals with a catalytic converter for treating motor vehicle exhaust gases, comprising a catalytically active coating layer as above described.

The use of a mixed oxide or of the composition as above described in the preparation of a catalytic converter is also encompassed by the present invention as a process for the treatment of exhaust gases from internal combustion engines, characterized in that use is made of a catalytic converter comprising a coating layer of the invention.

### BRIEF DESCRIPTION OF THE DRAWING

The terms Fig., Figs., Figure, and Figures are used interchangeably in the specification to refer to the corresponding figure in the drawing.

Other characteristics, details and advantages of the invention will become even more fully apparent on reading the description and the appended figure.

### FIGURE

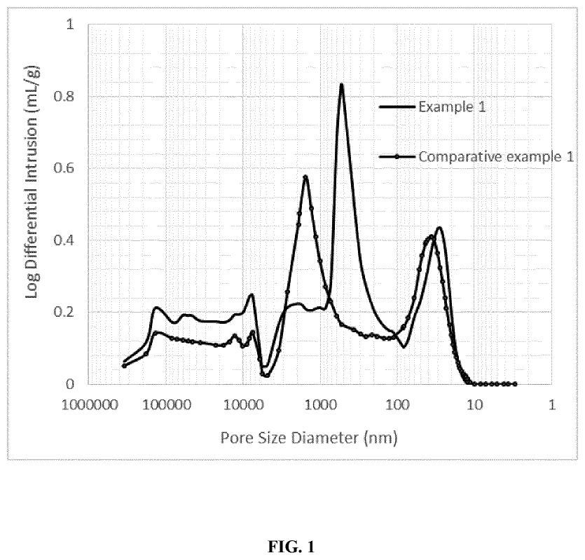

FIG. 1 represents a chart of the porosity profile. The vertical axis represents dV/d log D, the logarithm of differential intrusion in mL/g, the horizontal axis represents the pore size diameter in nm. FIG. 1 presents the results obtained in example 1 (continuous line) and comparative example 1 (dotted line).

### DESCRIPTION OF THE INVENTION

### Definitions

Within the meaning of the invention, the specific surface area is understood to mean the BET (Brunauer-Emmett-Teller) specific surface area (SBET, SSA or SA) determined by nitrogen adsorption.

The term “specific surface area (BET, SBET, SSA or SA)” is understood to mean the BET specific surface area determined by nitrogen adsorption. The specific surface area is well-known to the skilled person and is measured according to the Brunauer-Emmett-Teller method. The theory of the method was originally described in the periodical “The Journal of the American Chemical Society, 60, 309 (1938)”. More detailed information about the theory may also be found in chapter 4 of “Powder surface area and porosity”, 2^{nd} edition, ISBN 978-94-015-7955-1. The method of nitrogen adsorption is disclosed in standard ASTM D 3663-03 (reapproved 2008). In practice, the specific surface areas (BET) may be determined automatically with the appliance Flowsorb 112300 or the appliance Tristar 3000 of Micromeritics according to the guidelines of the constructor. They may also be determined automatically with a Macsorb analyzer model 1-1220 of Mountech according to the guidelines of the constructor. Prior to the measurement, the samples are degassed by heating at a temperature of at most 300° C. to remove the adsorbed volatile species, optionally under vacuum. More specific conditions may be found in the examples.

The porosities indicated are measured by mercury intrusion porosimetry in accordance with the standard ASTM D 4284-83 (reapproved 2008) (“Standard method for determining pore volume distribution of catalysts by mercury intrusion porosimetry”).

Within the meaning of the invention, rare earth metal (REM) is understood to mean the elements of the group consisting of scandium, yttrium and the elements of the Periodic Table with an atomic number between 57 and 71 inclusive.

A rare earth element as defined by IUPAC is one of a set of seventeen chemical elements in the periodic table, specifically the fifteen lanthanides, as well as scandium and yttrium. The rare earth elements are cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y).

Throughout the text of the present application, the proportions are given as weight of oxide relative to the mixed oxide as a whole, unless otherwise indicated.

Within the meaning of the invention, it is considered that cerium oxide is in the form of ceric oxide (CeO₂), that the oxides of the REM are in the form REM₂O₃, with the exception of praseodymium, expressed in the form Pr₆O₁₁, and that zirconium oxide and hafnium oxides are in the forms ZrO₂ and HfO₂.

It is specified, for the continuation of the description, that, unless otherwise indicated, in the ranges of values that are given, the values at the limits are included.

As used herein, the singular forms “a”, “an”, and “the” include both singular and plural referents unless the context clearly dictates otherwise. By way of example, “a compound” means one compound or more than one compound.

Within the meaning of the invention, the tapped density is to be understood as the density of a powder sample obtained after mechanically tapping.

According to the invention, the pore size is to be understood as the maximum of the pore size distribution in dV/d log D curve for pore size below 200 nm, unless otherwise defined.

### DETAILED DESCRIPTION

Should the disclosure of any patents, patent applications, and publications which are incorporated herein by reference conflict with the description of the present application to the extent that it may render a term unclear, the present description shall take precedence.

### Mixed Oxides

The present invention deals with mixed oxides of zirconium, cerium, lanthanum and optionally of at least one rare earth metal (REM) other than cerium and lanthanum, the proportions by weight of these elements, expressed as oxide equivalent, with respect to the total weight of the mixed oxide are between 8% and 47% of cerium (C); between 1% and 10% of lanthanum (L); between 0% and 15% of the REM other than cerium and lanthanum; the remainder as zirconium (Z).

The mixed oxides of the invention are additionally characterized by a high thermal resistance. This resistance is necessary as the coating needs to withstand high temperatures. In this respect, it must be borne in mind that gasoline engines are operated with a predominantly stoichiometric air/fuel mixture, so that the exhaust gases usually exhibit significantly higher temperatures than for lean burn engines. It is known that the temperatures at which a filter for gasoline engines operates are thus higher than for more conventional Diesel Particulate Filters.

The mixed oxides of the invention additionally exhibit a BET specific surface area of at least 30.0 m²/g after calcination at a temperature of 1100° C. for 4 hours and a BET specific surface area of at least 50.0 m²/g after calcination at a temperature of 1000° C. for 4 hours.

The mixed oxides of the invention are additionally characterized by the derivative curve (dV/d log D) obtained by mercury porosimetry after calcination at a temperature of 1100° C. for 4 hours which exhibits, in the range of the pores with a diameter of less than or equal to 200 nm, one peak for which the maximum corresponds to a pore diameter, denoted Dp,1100° C./4 h, of between 25.0 and 40.0 nm, V and D respectively denoting the pore volume and the pore diameter.

The mixed oxides of the invention are additionally characterized by a ratio R comprised between 0.50 and 0.60 that is defined by the formula: R=V1/V2 wherein V1 is the pore volume developed by the pores for which the diameter in nm is between (Dp,1100° C./4 h−15) and (Dp,1100° C./4 h+15); V2 is the pore volume developed by the pores for which the diameter is less than or equal to 200 nm; V1 and V2 being determined by mercury porosimetry on the mixed oxide after calcination at 1100° C. for 4 h.

Mercury porosimetry is a standard technique used in the field of porous catalysts and consists in the progressive intrusion of mercury into the pores of a porous structure under controlled pressures. The porosity is measured by mercury intrusion according to the well-known techniques in the field. The porosity may be determined according to the guidelines of the constructor using a Micromeritics Autopore IV 9500 Automatic Mercury Porosimeter. The porosimeter comprises a powder penetrometer. The method is based on the determination of the pore volume as a function of the pore size (V=f(D), V denoting the pore volume and D denoting the pore diameter). From the data, it is possible to obtain a curve (C) giving the derivative dV/d log D.

The specificity of the method of measure is given below in the paragraph “Method of measure”.

In a specific embodiment of the invention, the mixed oxides of the invention exhibit a BET specific surface area after calcination at a temperature of 1100° C. for 4 hours of at least 30.0 m²/g, at least 32.0 m²/g, preferably at least 34.0 m²/g, even more preferably at least 36.0 m²/g.

In a more specific aspect of the invention, the mixed oxides of the invention exhibits a BET specific surface area after calcination at a temperature of 1100° C. for 4 hours comprised between 30.0 m²/g and 40.0 m²/g, preferably comprised between 32.0 m²/g and 40.0 m²/g, preferably comprised between 34.0 m²/g and 40.0 m²/g, and even more preferably comprised between 36.0 m²/g and 40.0 m²/g.

In a specific embodiment of the invention, the mixed oxides of the invention exhibits a BET specific surface area after calcination at a temperature of 1000° C. for 4 hours of at least 50.0 m²/g, at least 55.0 m²/g, at least 60.0 m²/g, preferably at least 65.0 m²/g.

In a more specific aspect of the invention, the mixed oxides of the invention exhibit a BET specific surface area between 50.0 m²/g and 70.0 m²/g, preferably between 55.0 m²/g and 70.0 m²/g, preferably between 60.0 m²/g and 70.0 m²/g, even more preferably between 65.0 m²/g and 70.0 m²/g.

In a further aspect of the invention, the mixed oxides of the invention also exhibit a BET specific surface area comprised between 30.0 m²/g and 40.0 m²/g after calcination at a temperature of 1100° C. for 4 hours and a BET specific surface area of comprised between 50.0 m²/g and 70.0 m²/g after calcination at a temperature of 1000° C. for 4 hours.

In a further aspect of the invention, the mixed oxides of the invention additionally exhibit a BET specific surface area preferably comprised between 30.0 m²/g and 40.0 m²/g, preferably between 32.0 m²/g and 40.0 m²/g, more preferably comprised between 34.0 m²/g and 40.0 m²/g, and even more preferably comprised between 36.0 m²/g and 40.0 m²/g after calcination at a temperature of 1100° C. for 4 hours and a BET specific surface area of comprised preferably between 50.0 m²/g and 70.0 m²/g, preferably between 55.0 m²/g and 70.0 m²/g, preferably between 60.0 m²/g and 70.0 m²/g, even more preferably between 65.0 m²/g and 70.0 m²/g after calcination at a temperature of 1000° C. for 4 hours.

Accordingly the present invention deals with a mixed oxide of zirconium, cerium, lanthanum and optionally of at least one rare earth metal other than cerium and lanthanum (REM), the proportions by weight of these elements, expressed as oxide equivalent, with respect to the total weight of the mixed oxide being as follows:
between 8% and 47% of cerium;
between 1% and 10% of lanthanum;
between 0% and 15% of the rare earth metal other than cerium and lanthanum;
the remainder as zirconium,
   characterized in that the mixed oxide exhibits:
a BET specific surface area preferably comprised between 30.0 m²/g and 40.0 m²/g, preferably between 32.0 m²/g and 40.0 m²/g, more preferably comprised between 34.0 m²/g and 40.0 m²/g, and even more preferably comprised between 36.0 m²/g and 40.0 m²/g after calcination at a temperature of 1100° C. for 4 hours;
a BET specific surface area of comprised preferably between 50.0 m2/g and 70.0 m2/g, preferably between 55.0 m2/g and 70.0 m2/g, preferably between 60.0 m2/g and 70.0 m2/g, even more preferably between 65.0 m2/g and 70.0 m2/g after calcination at a temperature of 1000° C. for 4 hours;
a derivative curve (dV/d log D) obtained by mercury porosimetry on the mixed oxide after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter and
a ratio R defined by:

$$R = V 1 / V 2$$

wherein:
V1 is the pore volume developed by the pores for which the diameter in nm is between (Dp,1100° C./4 h−15) and (Dp,1100° C./4 h+15);
V2 is the pore volume developed by the pores for which the diameter is less than or equal to 200 nm;
V1 and V2 being determined by mercury porosimetry on the mixed oxide after calcination at 1100° C. for 4 h; and
   wherein R is comprised between 0.50 and 0.60.

In a further aspect of the invention, the mixed oxide is characterized in that the derivative curve (dV/d log D), obtained by mercury porosimetry on the mixed oxide after calcination at a temperature of 900° C. for 4 hours, does not exhibit two distinct peaks.

The mixed oxides of the invention may comprise hafnium. Accordingly and in a specific aspect, the proportion by weight of hafnium in the mixed oxide is less than or equal to 2.5%, indeed even less than or equal to 2.0%, expressed as oxide equivalent with respect to the total weight of the mixed oxide.

In a further aspect, the mixed oxides of the invention comprise s cerium (Ce), lanthanum (La), REM other than cerium and lanthanum, Zirconium (Zr) and (Hafnium) Hf which are present in the form of oxide, of hydroxide or of oxyhydroxide or any combination thereof.

In a preferred aspect, the mixed oxides of the invention comprises Ce, La, REM, Zr and Hf that are present in the form of oxide.

In another aspect, the mixed oxides of the invention are characterized in that the REM other than cerium and lanthanum is chosen from yttrium, neodymium, praseodymium, or any combination thereof.

In a specific aspect of the invention, the mixed oxides of the invention comprises only yttrium as REM other than cerium and lanthanum.

In another specific aspect of the invention, the mixed oxides of the invention comprises cerium, zirconium and only two REM other than cerium and lanthanum, which may be yttrium and neodymium or else yttrium and praseodymium. In a further aspect, the mixed oxide of the invention does not comprise any rare REM than cerium and lanthanum.

In a further aspect, the mixed oxide of the invention comprises or consists essentially of a mixture of oxides of zirconium, cerium, and lanthanum, and optionally of at least one REM other than cerium and lanthanum and optionally of hafnium.

In a still further aspect, the mixed oxide of the invention consists essentially of the following elements:
Zirconium, cerium, lanthanum, yttrium and optionally hafnium;
Zirconium, cerium, lanthanum, yttrium, neodymium and optionally hafnium;
Zirconium, cerium, lanthanum, yttrium, praseodymium and optionally hafnium;
Zirconium, cerium, lanthanum, neodymium, praseodymium and optionally hafnium or
Zirconium, cerium, lanthanum and optionally hafnium.

As far as the proportion of zirconium is concerned, zirconium is present as the remainder in the mixed oxide. The total of all the elements of the mixed oxide of the invention being 100%, the proportion of zirconium thus corresponds to the complement to 100% of the other elements of the mixed oxide.

This is to be understood to mean that the mixed oxides of the invention do not comprise another element oxide other than those cited and capable of having an influence on the characteristics of the mixed oxides of the invention. The mixed oxides of the invention may comprise elements such as impurities that may arise in particular from its preparation process, for example from the starting materials or starting reactants used.

In a specific aspect of the invention, the mixed oxide is characterized in that the proportion by weight of the cerium, expressed as oxide equivalent, may be between 8.0 and 47.0%, preferably between 10.0 and 40.0%.

In a specific aspect of the invention, the mixed oxide is characterized in that the proportion by weight of the lanthanum, expressed as oxide equivalent, may be between 1.0 and 10.0%, preferably between 3.5 and 5.0%.

In a specific aspect of the invention, the mixed oxide is characterized in that the proportion by weight of the rare earth metal other than cerium and lanthanum, expressed as oxide equivalent, may be between 0 and 15.0%, preferably between 1.0 and 15.0%, more preferably between 5.0 and 13.0%.

In a specific aspect of the invention, the mixed oxide is characterized in that the proportion by weight of the zirconium, expressed as oxide equivalent, may be between 40.0% and 91.0%, preferably between 44.0 and 80.0%, more preferably between 44.0 and 76.0%.

According to the invention, the proportions by weight of the mixed oxides of zirconium, cerium, lanthanum, optionally hafnium and optionally of at least one REM other than cerium and lanthanum, are expressed as oxide equivalent as described, with respect to the total weight of the mixed oxide.

Accordingly the present invention deals with a mixed oxide of zirconium, cerium, lanthanum and optionally of at least one rare earth metal other than cerium and lanthanum (REM), the proportions by weight of these elements, expressed as oxide equivalent, with respect to the total weight of the mixed oxide being as follows:
between 8% and 47% of cerium, preferably between 10.0 and 40.0%;
between 1% and 10% of lanthanum, preferably between 3.5 and 5.0%;
between 0% and 15% of the rare earth metal other than cerium and lanthanum, preferably between 1.0 and 15%, more preferably between 5.0 and 13.0%;
the remainder as zirconium,
   characterized in that the mixed oxide exhibits:
a BET specific surface area preferably comprised between 30.0 m2/g and 40.0 m2/g, preferably between 32.0 m2/g and 40.0 m2/g, more preferably comprised between 34.0 m2/g and 40.0 m2/g, and even more preferably comprised between 36.0 m2/g and 40.0 m2/g after calcination at a temperature of 1100° C. for 4 hours;
a BET specific surface area of comprised preferably between 50.0 m2/g and 70.0 m2/g, preferably between 55.0 m2/g and 70.0 m2/g, preferably between 60.0 m2/g and 70.0 m2/g, even more preferably between 65.0 m2/g and 70.0 m2/g after calcination at a temperature of 1000° C. for 4 hours;
a derivative curve (dV/d log D) obtained by mercury porosimetry on the mixed oxide after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter and
a ratio R defined by:

$$R = V 1 / V 2$$

wherein:
   V1 is the pore volume developed by the pores for which the diameter in nm is between (Dp,1100° C./4 h−15) and (Dp,1100° C./4 h+15);
   V2 is the pore volume developed by the pores for which the diameter is less than or equal to 200 nm;
   V1 and V2 being determined by mercury porosimetry on the mixed oxide after calcination at 1100° C. for 4 h; and
wherein R is comprised between 0.50 and 0.60.

In a particular aspect of the invention, the mixed oxide is also characterized by its pore volume V2. According to the invention, the pore volume V2 is the pore volume developed by the pores for which the diameter is less than or equal to 200 nm;

Said pore volume is determined by mercury porosimetry on the mixed oxide after calcination at 1100° C. for 4 h.

Thus, the mixed oxide of the invention is additionally characterized by a pore volume V2 of 0.20 to 0.50 ml/g, in particular of 0.24 to 0.41 ml/g.

In a further aspect, the mixed oxide of the invention is characterized in that the derivative curve (dV/d log D) obtained by mercury porosimetry on the mixed oxide after calcination at a temperature of 1100° C. for 4 hours exhibits, in the range of the pores with a diameter of less than or equal to 200 nm, one peak for which the maximum corresponds to a pore diameter Dp,1100° C./4 h of between 25 and 40 nm, preferably between 25 and 38 nm, V and D respectively denoting the pore volume and the pore diameter.

Accordingly the present invention deals with a mixed oxide of zirconium, cerium, lanthanum and optionally of at least one rare earth metal other than cerium and lanthanum (REM), the proportions by weight of these elements, expressed as oxide equivalent, with respect to the total weight of the mixed oxide being as follows:
between 8% and 47% of cerium, preferably between 10.0 and 40.0%;
between 1% and 10% of lanthanum, preferably between 3.5 and 5.0%;
between 0% and 15% of the rare earth metal other than cerium and lanthanum, preferably between 1.0 and 15%, more preferably between 5.0 and 13.0%;
the remainder as zirconium,
   characterized in that the mixed oxide exhibits:
a BET specific surface area preferably comprised between 30.0 m2/g and 40.0 m2/g, preferably between 32.0 m2/g and 40.0 m2/g, more preferably comprised between 34.0 m2/g and 40.0 m2/g, and even more preferably comprised between 36.0 m2/g and 40.0 m2/g after calcination at a temperature of 1100° C. for 4 hours;
a BET specific surface area of comprised preferably between 50.0 m2/g and 70.0 m2/g, preferably between 55.0 m2/g and 70.0 m2/g, preferably between 60.0 m2/g and 70.0 m2/g, even more preferably between 65.0 m2/g and 70.0 m2/g after calcination at a temperature of 1000° C. for 4 hours;
a derivative curve (dV/d log D) obtained by mercury porosimetry on the mixed oxide after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter and
a ratio R defined by:

$$R = V 1 / V 2$$

wherein:
   V1 is the pore volume developed by the pores for which the diameter in nm is between (Dp,1100° C./4 h−15) and (Dp,1100° C./4 h+15);
   V2 is the pore volume developed by the pores for which the diameter is less than or equal to 200 nm; and
wherein R is comprised between 0.50 and 0.60, and
   a pore volume V2 of 0.20 to 0.50 ml/g, preferably from 0.24 to 0.41 ml/g
wherein V1 and V2 being determined by mercury porosimetry on the mixed oxide after calcination at 1100° C. for 4 h.

The mixed oxides of the invention can also be defined as consisting essentially of mixed oxides of zirconium, of cerium, of lanthanum and optionally of at least one REM other than cerium and lanthanum, the proportions by weight of these elements, expressed as oxide equivalent, with respect to the total weight of the mixed oxide are between 8% and 47% of cerium (C); between 1% and 10% of lanthanum (L); between 0% and 15% of the rare earth metal other than cerium and lanthanum; the remainder as zirconium (Z), the proportions by weight of these elements, expressed as oxide equivalent as described, with respect to the total weight of the mixed oxide, and characterized by:
a BET specific surface area of at least 30 m²/g after calcination at a temperature of 1100° C. for 4 hours and a BET specific surface area of at least 50 m²/g after calcination at a temperature of 1000° C. for 4 hours,
a derivative curve (dV/d log D) obtained by mercury porosimetry after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, V and D respectively denoting the pore volume and the pore diameter, and
a ratio R defined by:

$$R = V 1 / V 2$$

wherein:
V1 is the pore volume developed by the pores for which the diameter in nm is between (Dp,1100° C./4 h−15) and (Dp,1100° C./4 h+15);
V2 is the pore volume developed by the pores for which the diameter is less than or equal to 200 nm;
V1 and V2 being determined by mercury porosimetry on the mixed oxide after calcination at 1100° C. for 4 h; and
   wherein R is comprised between 0.50 and 0.60.

In another aspect, the mixed oxides of the invention can also be defined as consisting essentially of mixed oxides of zirconium, of cerium, of lanthanum and optionally of at least one REM other than cerium and lanthanum, the proportions by weight of these elements, expressed as oxide equivalent, with respect to the total weight of the mixed oxide are between 8% and 47% of cerium (C); between 1% and 10% of lanthanum (L); between 0% and 15% of the rare earth metal other than cerium, between 0% and 2.5% of hafnium and lanthanum; the remainder as zirconium (Z), the proportions by weight of these elements, expressed as oxide equivalent as described, with respect to the total weight of the mixed oxide, and characterized by:
a BET specific surface area of at least 30 m²/g after calcination at a temperature of 1100° C. for 4 hours and a BET specific surface area of at least 50 m²/g after calcination at a temperature of 1000° C. for 4 hours,
a derivative curve (dV/d log D) obtained by mercury porosimetry after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, V and D respectively denoting the pore volume and the pore diameter, and
a ratio R defined by:

$$R = V 1 / V 2$$

wherein:
V1 is the pore volume developed by the pores for which the diameter in nm is between (Dp,1100° C./4 h−15) and (Dp,1100° C./4 h+15);
V2 is the pore volume developed by the pores for which the diameter is less than or equal to 200 nm;
V1 and V2 being determined by mercury porosimetry on the mixed oxide after calcination at 1100° C. for 4 h; and
   wherein R is comprised between 0.50 and 0.60.

The expression “consisting essentially of” is to be interpreted as follows: “a mixed oxide consisting essentially of” means that other elements in addition to the mandatory elements can be present, provided that the essential characteristics of the claimed composition are not materially affected by the presence of said other elements. All the technical features and embodiments previously disclosed also apply to this particular mixed oxide.

In a further aspect, the mixed oxide of the invention as described just above is characterized in that the derivative curve (dV/d log D) obtained by mercury porosimetry on the mixed oxide after calcination at a temperature of 1100° C. for 4 hours exhibits, in the range of the pores with a diameter of less than or equal to 200 nm, one peak for which the maximum corresponds to a pore diameter Dp,1100° C./4 h of between 25 and 38 nm, V and D respectively denoting the pore volume and the pore diameter.

According to the present invention, Dp,1000° C./4 h is the pore diameter determined by mercury porosimetry on the mixed oxide after calcination at 1000° C. for 4 h, Dp,1100° C./4 h is the pore diameter determined by mercury porosimetry on the mixed oxide after calcination at 1100° C. for 4 h.

As such, the mixed oxide of the invention is a mixed oxide essentially consisting of zirconium, cerium, lanthanum and optionally of at least one rare earth metal other than cerium and lanthanum (REM), the proportions by weight of these elements, expressed as oxide equivalent, with respect to the total weight of the mixed oxide being as follows:
between 8% and 47% of cerium, preferably between 10.0 and 40.0%;
between 1% and 10% of lanthanum, preferably between 3.5 and 5.0%;
between 0% and 15% of the rare earth metal other than cerium and lanthanum, preferably between 5.0 and 13.0%;
the remainder as zirconium,
   characterized in that the mixed oxide exhibits:
a BET specific surface area preferably comprised between 30.0 m2/g and 40.0 m2/g, preferably between 32.0 m2/g and 40.0 m2/g, more preferably comprised between 34.0 m2/g and 40.0 m2/g, and even more preferably comprised between 36.0 m2/g and 40.0 m2/g after calcination at a temperature of 1100° C. for 4 hours;
a BET specific surface area of comprised preferably between 50.0 m2/g and 70.0 m2/g, preferably between 55.0 m2/g and 70.0 m2/g, preferably between 60.0 m2/g and 70.0 m2/g, even more preferably between 65.0 m2/g and 70.0 m2/g after calcination at a temperature of 1000° C. for 4 hours;
a derivative curve (dV/d log D) obtained by mercury porosimetry on the mixed oxide after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter, and
a ratio R defined by:

$$R = V 1 / V 2$$

Wherein V1 is the pore volume developed by the pores for which the diameter in nm is between (Dp,1100° C./4 h−15) and (Dp,1100° C./4 h+15); V2 is the pore volume developed by the pores for which the diameter is less than or equal to 200 nm; and wherein R is comprised between 0.50 and 0.60 and
a pore volume V2 of 0.20 to 0.50 ml/g, particularly 0.24 to 0.41 ml/g wherein V2 is the pore volume developed by the pores for which the diameter is less than or equal to 200 nm,
   Wherein V1 and V2 being determined by mercury porosimetry of the mixed oxide after calcination at 1100° C. for 4 hours.

In a specific aspect of the invention, the mixed oxide is additionally characterized in that the derivative curve (dV/d log D) obtained by mercury porosimetry on the mixed oxide after calcination at a temperature of 900° C. for 4 hours exhibits, in the range of the pores with a diameter of less than or equal to 200 nm, one peak for which the maximum corresponds to a pore diameter denoted Dp,900° C./4 h and such that the difference in absolute value (Dp,1100° C./4 h)−(Dp, 900° C./4 h) is less than or equal to 15 nm, indeed even less than or equal to 12 nm, indeed even less than or equal to 11 nm.

In a specific aspect of the invention, the mixed oxide is additionally characterized in that the derivative curve (dV/d log D) obtained by mercury porosimetry on the mixed oxide after calcination at a temperature of 900° C. for 4 hours exhibits, in the range of the pores with a diameter of less than or equal to 200 nm, one peak for which the maximum corresponds to a pore diameter denoted Dp,900° C./4 h and such that the difference in absolute value (Dp,1100° C./4 h)−(Dp, 900° C./4 h) is not zero.

In a still further aspect of the invention, the mixed oxide of the invention is a mixed oxide of zirconium, cerium, lanthanum and optionally of at least one REM other than cerium and lanthanum, the proportions by weight of these elements, expressed as oxide equivalent, with respect to the total weight of the mixed oxide being as follows:
between 8% and 47% of cerium, preferably between 10.0 and 40.0%;
between 1% and 10% of lanthanum, preferably between 3.5 and 5.0%;
between 0% and 15% of the rare earth metal other than cerium and lanthanum, preferably between 5.0 and 13.0%;
the remainder as zirconium,
   characterized in that the mixed oxide exhibits:
a BET specific surface area preferably comprised between 30.0 m2/g and 40.0 m2/g, preferably between 32.0 m2/g and 40.0 m2/g, more preferably comprised between 34.0 m2/g and 40.0 m2/g, and even more preferably comprised between 36.0 m2/g and 40.0 m2/g after calcination at a temperature of 1100° C. for 4 hours;
a BET specific surface area of comprised preferably between 50.0 m2/g and 70.0 m2/g, preferably between 55.0 m2/g and 70.0 m2/g, preferably between 60.0 m2/g and 70.0 m2/g, even more preferably between 65.0 m2/g and 70.0 m2/g after calcination at a temperature of 1000° C. for 4 hours;
a derivative curve (dV/d log D) obtained by mercury porosimetry on the mixed oxide after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter;
the derivative curve (dV/d log D) obtained by mercury porosimetry on the mixed oxide after calcination at a temperature of 900° C. for 4 hours exhibits, in the range of the pores with a diameter of less than or equal to 200 nm, one peak for which the maximum corresponds to a pore diameter denoted Dp,900° C./4 h and such that the difference in absolute value (Dp,1100° C./4 h)−(Dp, 900° C./4 h) is less than or equal to 15 nm, indeed even less than or equal to 12 nm, indeed even less than or equal to 11 nm,
a ratio R defined by:

$$R = V 1 / V 2$$

in which V1 is the pore volume developed by the pores for which the diameter in nm is between (Dp,1100° C./4 h−15) and (Dp,1100° C./4 h+15); V2 is the pore volume developed by the pores for which the diameter is less than or equal to 200 nm; wherein R is comprised between, 0.50 and 0.60, and
a pore volume V2 of 0.24 to 0.41 ml/g wherein V2 is the pore volume developed by the pores for which the diameter is less than or equal to 200 nm,
   wherein V1 and V2 are determined by mercury porosimetry of the mixed oxide after calcination at 1100° C. for 4 hours.

The mixed oxide according to the invention is provided in the form of a powder, the median diameter d50 of which, determined by laser diffraction, over a distribution by volume, is comprised between 2.5 and 20.0 μm, preferably between 3.0 to 15.0 μm, and more preferably between 3.0 to 10.0 μm.

The mixed oxide according to the invention is provided in the form of a powder, the median diameter d10 of which, determined by laser diffraction, over a distribution by volume, of between 0.4 and 2.0 μm, preferably from 0.5 to 1.8 μm.

The mixed oxide according to the invention is provided in the form of a powder, the median diameter d90 of which, determined by laser diffraction, over a distribution by volume, of between 8.0 and 60.0 μm, preferably from 10.0 to 50.0. μm, and more preferably from 12.0 to 48.0 μm.

The mixed oxide according to the invention is provided in the form of a powder, the median diameter d99 of which, determined by laser diffraction, over a distribution by volume, of between 20.0 and 120.0 μm, preferably from 25.0 to 110.0 μm, and more preferably from 25.0 to 100.0 μm.

d10, d50, d90 and d99 (in m) have the usual meaning used in statistics. Thus, dn (n=10, 50, 90 or 99) represents the particle size such that n % of the particles is less than or equal to said size. d50 thus represents the median value. They are determined from a distribution of size of the particles (in volume) obtained with a laser diffraction particle size analyzer. The conditions of measurement of the distribution given in the examples may apply.

According to the present invention, the dn is determined by laser diffraction notably with a Beckman Coulter LS 13320 laser diffraction particle size analyzer (Beckman Coulter, Inc.) using the standard procedure predetermined by the instrument software.

The Fraunhofer mode may be used following the guidelines of the constructor (www.beckmancoulter.com/wsrportal/techdocs?docname=B05577AB.pdf). A relative refractive index of 1.6 is used.

The measurement may be carried out in water optionally in the presence of a dispersant such as sodium hexametaphosphate.

In a further aspect, the mixed oxide of the invention is additionally characterized by a tapped density of the mixed oxide which is equal to or greater than 0.4 g/cm³, preferably equal to or greater than 0.5 g/cm³; preferably equal to or greater than 0.6 g/cm³; preferably equal to or greater than 0.7 g/cm³; preferably equal to or greater than 0.8 g/cm³; preferably equal to or greater than 0.85 g/cm³.

The tapped density according to the invention may be measured as follows.

The requested equipment for said measure are:
a class A graduated cylinder of 250 mL readable to 2 mL (tolerance±1.0 mL) with an external diameter of 40 mm and a mass between 192 to 196 g.
a settling apparatus capable of producing, in 1 min, either nominally 250 taps from a height of 3 mm. The support for the graduated cylinder has a mass of 450 g. The PT-TD300 model from Pharma Test is able to measure the tapped density (www.pharma-test.de/wp-content/uploads/2017/08/ptag-49-30000-pt-td300-e.pdf)
a laboratory balance able to weigh at ±0.1 g.

Weigh precisely about 100 g (Initial Mass) and pour into the dry graduated cylinder. The graduated cylinder containing the powder sample is then secured on the cylinder support of the apparatus, and 1470 taps are carried out.

The volume Volume₁ is read to the nearest 1 mL.

1470 taps are carried out once again and the volume Volume₂ is read to the nearest 1 mL.

If the difference between Volume₁ and Volume₂ is less than 2 mL, Volume₂ is the Tapped Volume.

If the difference between Volume₁ and Volume₂ is more than 2 mL, carry out 2940 additional taps. Read the volume Volume₃ to the nearest 1 mL.
If the difference between Volume₂ and Volume₃ is less than 2 mL, Volume₃ is the Tapped Volume.

If the difference between Volume₂ and Volume₃ is more than 2 mL, carry out 5880 additional taps. Read the volume Volume₄ to the nearest 1 mL.
If the difference between Volume₃ and Volume₄ is less than 2 mL, Volume₄ is the Tapped Volume

If the difference between Volume₃ and Volume₄ is more than 2 mL, the procedure is repeated by doubling the number of taps at each step until the difference between Volumeₙ₋₁ and Volumeₙ is less than 2 mL. Volumeₙ is the Tapped Volume.

The formula to calculate the tapped density is:

$$Tapped Density ( g / mL ) = \frac{Initial Mass ( g )}{Tapped Volume ( mL )}$$

The result is rounded to the nearest hundredth.

Accordingly, in a still further aspect of the invention, the mixed oxide of the invention is a mixed oxide of zirconium, cerium, lanthanum and optionally of at least one rare earth metal other than cerium and lanthanum (REM), the proportions by weight of these elements, expressed as oxide equivalent, with respect to the total weight of the mixed oxide being as follows:
between 8% and 47% of cerium, preferably between 10.0 and 40.0%;
between 1% and 10% of lanthanum, preferably between 3.5 and 5.0%;
between 0% and 15% of the rare earth metal other than cerium and lanthanum, preferably between 5.0 and 13.0%;
the remainder as zirconium,
   characterized in that the mixed oxide exhibits:
a BET specific surface area preferably comprised between 30.0 m2/g and 40.0 m2/g, preferably between 32.0 m2/g and 40.0 m2/g, more preferably comprised between 34.0 m2/g and 40.0 m2/g, and even more preferably comprised between 36.0 m2/g and 40.0 m2/g after calcination at a temperature of 1100° C. for 4 hours;
a BET specific surface area of comprised preferably between 50.0 m2/g and 70.0 m2/g, preferably between 55.0 m2/g and 70.0 m2/g, preferably between 60.0 m2/g and 70.0 m2/g, even more preferably between 65.0 m2/g and 70.0 m2/g after calcination at a temperature of 1000° C. for 4 hours;
a derivative curve (dV/d log D) obtained by mercury porosimetry on the mixed oxide after calcination at a temperature of 1100° C. for 4 hours that exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter
the derivative curve (dV/d log D) obtained by mercury porosimetry on the mixed oxide after calcination at a temperature of 900° C. for 4 hours exhibits, in the range of the pores with a diameter of less than or equal to 200 nm, one peak for which the maximum corresponds to a pore diameter denoted Dp,900° C./4 h and such that the difference in absolute value (Dp,1100° C./4 h)−(Dp, 900° C./4 h) is less than or equal to 15 nm, indeed even less than or equal to 12 nm, indeed even less than or equal to 11 nm, and
a ratio R defined by:

$$R = V 1 / V 2$$

wherein V1 is the pore volume developed by the pores for which the diameter in nm is between (Dp,1100° C./4 h−15) and (Dp,1100° C./4 h+15); V2 is the pore volume developed by the pores for which the diameter is less than or equal to 200 nm; and
wherein R is comprised between, 0.50 and 0.60, and
a pore volume V2 of 0.24 to 0.41 ml/g wherein V2 is the pore volume developed by the pores for which the diameter is less than or equal to 200 nm,
   wherein V1 and V2 being determined by mercury porosimetry on the mixed oxide after calcination at 1100° C. for 4 h; and
a tapped density of the mixed oxide which is equal to or greater than 0.4 g/cm³, preferably equal to or greater than 0.5 g/cm³; preferably equal to or greater than 0.6 g/cm³; preferably equal to or greater than 0.7 g/cm³; preferably equal to or greater than 0.8 g/cm³; preferably equal to or greater than 0.85 g/cm³.

### Process for the Preparation of the Mixed Oxide

The present invention also relates to a process for the preparation of the mixed oxide as described above, comprising the following steps:

The first step (a1) of the process therefore consists in introducing an aqueous solution of cerium nitrate and of zirconium nitrate into a stirred vessel containing a basic aqueous solution. The basic solution may comprise alkali metal or alkaline-earth metal hydroxides. Use may also be made of secondary, tertiary or quaternary amines. However, amines and aqueous ammonia may be preferred since they reduce the risks of pollution by alkali metal or alkaline-earth metal cations. Mention may also be made of urea.

The basic aqueous solution may be used with a stoichiometric excess in order to be sure of optimum precipitation.

This bringing together is carried out with stirring.

The second step (a2) introduction of an aqueous solution of nitrate of the rare earth metal other than cerium and lanthanum is subsequently introduced into the mixture formed in step (a1), kept stirred s. this step is optional depending on the addition of an aqueous solution of nitrate of the rare earth metal (REM).

In an optional step (a2′) the mixture obtained at the end of step (a1) or (a2) is heated at a temperature comprised between 5° and 95° C.

According to a specific aspect of the invention, the concentration of the mixture at the end of (a1), (a2) or (a2′) is from 30 to 100 g/l expressed as metal oxides.

At the end of step (a1), (a2) or (a2′) an aqueous solution of lanthanum nitrate is subsequently introduced into the mixture formed in step (a2), (a2′) or (a1), the mixture is kept stirred (step (a3)).

At the end of step (a3) the mixture obtained is heated with stirring (step (a4)).

This heating can be carried out at a temperature of at least 100° C. and even more particularly at least 130° C. It can be between, for example, 100° C. and 160° C. The heating operation can be carried out by introducing the liquid medium into a closed chamber (closed reactor of the autoclave type). Under the temperature conditions given above, and in an aqueous medium, it can thus be specified, by way of illustration, that the pressure in the closed reactor can range between an upper value at 1 bar (105 Pa) and 165 bars (1.65×10⁷ Pa), preferably between 5 bar (5×10⁵ Pa) and 165 bar (1.65×10⁷ Pa). The heating can also be carried out in an open reactor for temperatures of about 100° C.

The heating is carried out under air.

The heating time can vary within broad limits, for example between 1 and 48 hours, preferably between 2 and 24 hours. Likewise, the increase in temperature is carried out at a rate that is not essential, and it is thus possible to reach the fixed reaction temperature by heating the medium for, for example, between 30 minutes and 4 hours, these values being given entirely by way of indication.

The next step (a5) of the process consists in adding, to the mixture, a templating agent.

The function of the templating agent is to control the porosity of the mixed oxide.

At step (a5) a templating agent is added, this templating agent comprises polar chemical groups which interact with the chemical groups at the surface of the mixture. According to the invention, the templating agent can be a combination of templating agents. The templating agent is removed subsequent to the calcination step.

The templating agent may be chosen from anionic surfactants, nonionic surfactants, polyethylene glycols and carboxylic acids and their salts, and surfactants of the carboxymethylated fatty alcohol ethoxylate type of any combination thereof. As regards this additive, reference may be made to the teaching of the application WO 98/45212 and use may be made of the surfactants described in this document.

Mention may be made, as surfactants of the anionic type, of ethoxycarboxylates, ethoxylated fatty acids, sarcosinates, phosphate esters, sulfates, such as alcohol sulfates, alcohol ether sulfates and sulfated alkanolamide ethoxylates, or sulfonates, such as sulfosuccinates, alkylbenzenesulfonates or alkylnaphthalenesulfonates or any combination thereof.

Mention may be made, as nonionic surfactants, of acetylenic surfactants, alcohol ethoxylates, alkanolamides, amine oxides, ethoxylated alkanolamides, long-chain ethoxylated amines, ethylene oxide/propylene oxide copolymers, sorbitan derivatives, ethylene glycol, propylene glycol, glycerol, polyglyceryl esters and their ethoxylated derivatives, alkylamines, alkylimidazolines, ethoxylated oils and alkylphenol ethoxylates. Mention may in particular be made of the products sold under the Igepal®, Dowanol®, Rhodamox® and Alkamide® brands or any combination thereof.

As regards the carboxylic acids, use may in particular be made of aliphatic mono- or dicarboxylic acids and, among these, more particularly of saturated acids. Mention may thus in particular be made of formic, acetic, propionic, butyric, isobutyric, valeric, caproic, caprylic, capric, lauric, myristic or palmitic acid or any combination thereof. Mention may be made, as dicarboxylic acids, of oxalic, malonic, succinic, glutaric, adipic, pimelic, suberic, azelaic and sebacic acids. Use may also be made of fatty acids and more particularly of saturated fatty acids or any combination thereof. They may in particular be saturated linear acids of formula CH3-(CH2)ₘ-COOH, m being an integer between 6 and 20, more particularly between 9 and 15. The salts of all the acids mentioned may also be used, in particular the ammonium salts. Mention may more particularly be made, by way of example, of lauric acid and ammonium laurate.

Finally, it is possible to use a surfactant which is chosen from those of the carboxymethylated fatty alcohol ethoxylate type. Product of the carboxymethylated fatty alcohol ethoxylate type is understood to mean the products composed of ethoxylated or propoxylated fatty alcohols comprising, at the chain end, a CH₂—COOH group. These products may correspond to the formula: R₁—O—(CR₂R₃—CR₄R₅—O)ₙ—CH₂—COOH in which R1 denotes a saturated or unsaturated carbon chain, the length of which is generally at most 22 carbon atoms, preferably at least 12 carbon atoms; R₂, R₃, R₄ and R₅ may be identical and represent hydrogen or else R₂ may represent a CH₃ group and R₃, R₄ and R₅ represent hydrogen; and n as a nonzero integer which may range up to 50 and more particularly between 5 and 15, these values being inclusive. It should be noted that a surfactant may be composed of a mixture of products of the above formula for which R1 may be saturated and unsaturated respectively or else products comprising both CH₂—CH₂—O— and —C(CH₂)—CH₂—O— groups.

The templating agent may be added directly to the mixture resulting from step (a4). In this case, it is preferably added to the mixture, the temperature of which is at most 60° C.

The amount of templating agent used, expressed as percentage by weight of templating agent with respect to the mixed oxide, is generally between 5% and 100%, more particularly between 15% and 60%.

At the end of step (a5) the mixture is optionally filtered and the precipitate is washed (a6). In a preferred aspect, the precipitate is washed with water.

In a (a7) step of the process of the invention, the precipitate recovered is subsequently calcined. This calcination makes it possible to develop the crystallinity of the product formed and it can also be adjusted and/or selected according to the subsequent operating temperature intended for the composition according to the invention, this being done while taking into account the fact that the specific surface area of the product decreases as the calcination temperature used increases. Such a calcination is generally carried out under air, but a calcination carried out, for example, under inert gas or under a controlled atmosphere (oxidizing or reducing) is very clearly not excluded.

Unless stated otherwise the calcination are carried out under air.

In practice, the calcination temperature is generally limited to a range of values of between 70° and 1100° C. and more particularly between 900° C. and 1100° C., even more particularly between 1000° C. and 1100° C.

The duration of the calcination is not critical and depends on the temperature. Purely by way of indication, it can be at least 2 hours and more particularly between 2 and 6 hours even more particularly between 2 and 4 hours.

Finally, but optionally, the mixed oxide obtained in step (a7) may be ground (a8).

In a particular aspect, the invention deals with a mixed oxide capable of being obtained by the process described above.

In another particular aspect, the invention deals with the present invention also relates to a process for the preparation of a mixed oxide, comprising the following steps:
(a1) an aqueous solution of cerium nitrate and of zirconium nitrate is introduced into a stirred vessel containing a basic aqueous solution;
(a2) optionally an aqueous solution of nitrate of the rare earth metal (other than cerium or lanthanum) is subsequently introduced into the mixture formed in step (a1), and kept stirred;
(a2′) optionally the mixture obtained at the end of step (a1) or (a2) is heated at a temperature comprised between 5° and 95° C.;
(a3) an aqueous solution of lanthanum nitrate is subsequently introduced into the mixture formed in step (a2), (a2′) or (a1), and kept stirred
(a4) the mixture obtained at the end of step (a3) is heated with stirring;
(a5) a templating agent is subsequently introduced into the mixture obtained in the preceding step;
(a6) optionally, the mixture is filtered and the precipitate is washed;
(a7) the precipitate obtained at the end of step (a6) is calcined at a temperature of between 700° C. and 1100°;
(a8) the mixed oxide obtained in step (a7) is optionally ground;
   wherein the mixed oxide is a mixed oxide of zirconium, cerium, lanthanum and optionally of at least one REM other than cerium and lanthanum, the proportions by weight of these elements, expressed as oxide equivalent, with respect to the total weight of the mixed oxide being as follows:
between 8% and 47% of cerium;
between 1% and 10% of lanthanum;
between 0% and 15% of the rare earth metal other than cerium and lanthanum;
between 0% and 2.5% of hafnium;
the remainder as zirconium.

### Composition Comprising the Mixed Oxide

The invention also relates to a composition comprising the mixed oxide as described above or obtained by the process as described above and a mixture with at least one mineral material.

According to a specific aspect, the composition comprises at least one mineral material chosen from alumina, titanium oxide, cerium oxide, zirconium oxide, silica, spinels, zeolites, silicates, crystalline silicoaluminophosphates or crystalline aluminophosphates or any combination thereof.

### Catalytically Active Coating Layer

The invention also relates to a catalytically active coating layer, deposited at the surface area of a solid support, prepared from the mixed oxide, obtained by the process or from a composition as described above.

In a further aspect, the catalytic converter is for treating motor vehicle exhaust gases, and comprises a coating layer as described above.

### Use of the Mixed Oxide

The mixed oxide of the invention may be used in the field of exhaust gas treatment. The mixed oxide of the invention may be used to reduce the amounts of pollutants present in an exhaust gas released by the internal combustion engine of a vehicle.

The mixed oxide may be used in the preparation of a catalytic converter which is used to treat exhaust gases released by the internal combustion engine of a vehicle. The catalytic converter comprises at least one catalytically active layer prepared by depositing a catalytic composition on a solid support. The function of the layer is to chemically convert some pollutants of the exhaust gas into products that are less harmful to the environment. The solid support may be a monolith made of ceramic, for example of cordierite, of silicon carbide, of alumina titanate or of mullite, or of metal, for example Fecralloy. The support is usually made of cordierite, exhibiting a large specific surface area and a low pressure drop. The monolith is often of the honeycomb type.

The catalytic composition comprises:
(i) at least one mineral material such as alumina;
(ii) one or more platinum group metals; and
(iii) at least one mixed oxide of the invention.

The mixed oxide may be used for the preparation of a catalytic wall-flow monolith. The catalytic wall-flow monolith comprises a porous support and the catalytic composition on the surface of the support. Wall-flow monoliths are well-known in the art for use as particulate filters. They work by forcing a flow of the exhaust gas (including particulate matter) to pass through the walls formed by the porous support. The porosity helps retain the particulate matter. The monolith preferably has a first face and a second face defining a longitudinal direction there between. In use, one of the first face and the second face will be the inlet face for exhaust gases and the other will be the outlet face for the treated exhaust gas. As is conventional for a wall-flow monolith, it has first and second pluralities of channels extending in the longitudinal direction. The first plurality of channels is open at the first face and closed at the second face. The second plurality of channels is open at the second face and closed at the first face. The channels are preferably parallel to each other to provide a constant wall thickness between the channels. As a result, gases entering one of the plurality of channels cannot leave the monolith without diffusing through the channel walls into the other plurality of channels. The channels are closed with the introduction of a sealant material into the open end of a channel.

Preferably, the number of channels in the first plurality is equal to the number of channels in the second plurality, and each plurality is evenly distributed throughout the monolith. Preferably, within a plane orthogonal to the longitudinal direction, the wall-flow monolith has from 100 to 500 channels per square inch (cpsi), preferably from 200 to 400 cpsi. For example, on the first face, the density of open first channels and closed second channels is from 200 to 400 channels per square inch. The channels can have cross sections that are rectangular, square, circular, oval, triangular, hexagonal, or other polygonal shapes.

In order to facilitate the passage of the exhaust gas to be treated through the channel walls, the monolith is formed out of a porous substrate. The substrate also acts as a support for holding the catalytic composition. Suitable materials for forming the porous substrate include ceramic-like materials such as cordierite, silicon carbide, silicon nitride, zirconia, mullite, spodumene, alumina-silica-magnesia or zirconium silicate, or of porous, refractory metal. Wall-flow substrates may also be formed of ceramic fibre composite materials. Preferred wall-flow substrates are formed from cordierite and silicon carbide. Such materials are able to withstand the environment, particularly high temperatures, encountered in treating the exhaust streams and can be made sufficiently porous. Such materials and their use in the manufacture of porous monolith substrates is well known in the art.

The catalytic composition is applied on the porous substrate in the form of a layer. Traditionally, the loading of the layer should not be too high to avoid back-pressure. The loading may be between 1.0 g/in³ to 0.1 g/in³, preferably from 0.7 g/in³ to 0.25 g/in³, and most preferred from 0.6 g/in 3 to 0.5 g/in³.

The catalytic composition comprises alumina, preferably gamma-alumina. The alumina may also comprise lanthanum, praseodymium or a combination of the two. Alumina is preferably a lanthanum-stabilized alumina. Alumina is an advantageous carrier material since it exhibits a high surface area and is a refractory metal oxide. This leads to good thermal capacity which is required for the high-temperature conditions encountered. The catalytic composition also comprises one or more platinum group metals (PGM). The PGM is selected from the group consisting of Pt, Pd, Rh, Re, Ir. The PGM serves to catalyze the reactions required to treat the exhaust gas and the combustion of the soot particles. Preferably the PGM is Pt, Pd and Rh; Pd and Rh; or Pd only; or Rh only.

A method that may used for the preparation of a catalytic wall-flow monolith is disclosed in WO 2017/109514, the content of which is entirely incorporated by reference. More particularly, the method disclosed in example 3 of WO 2017/109514 may be used.

### Process for the Treatment of Exhaust Gases

The invention also relates to a process for the treatment of exhaust gases from internal combustion engines, characterized in that use is made of a catalytic converter comprising a coating layer as described above.

The examples hereafter are intended to illustrate the invention without however limiting it.

### Methods of Measure According to the Present Invention:

### Measure of Pore Volumes and Pore Diameters

The pore volumes and pore diameters given are measured by mercury (Hg) porosimetry, using a Micromeritics Autopore IV 9500 porosimeter, and are calculated via the Washburn relationship with a theta contact angle equal to 1300 and a gamma surface tension equal to 485 Dynes/cm; the preparation of each sample is performed as follows: each sample is pre-dried for 2 hours in an oven at 200° C.

The following parameters may be used: penetrometer used: 3.2 ml; volume of the capillary: 0.412 ml; max. pressure (“head pressure”): 4.68 psi; contact angle: 130°; surface area tension of the mercury: 485 dynes/cm; density of the mercury: 13.5335 g/ml. At the start of the measurement, a vacuum of 50 mm Hg is applied to the sample for 5 min.

The equilibrium times are as follows: range of the low pressures (1.3-30 psi): 20 s-range of the high pressures (30-60 000 psi): 30 s. Prior to the measurement, the samples are degassed in an oven at 100° C. for a minimum of 15 min.

### Measure of the Specific Surface Area

The BET specific surface area are determined automatically of a Macsorb analyzer model I-1220 of Mountech. Prior to any measurement, the samples are carefully degassed to desorb the volatile adsorbed species. To do so, the samples may be heated at 210° C. for 30 min under vacuum in the cell of the appliance.

The BET measurement is carried out on 1 point at relative pressure P/P0 at 0.3.

The porosities indicated are measured by mercury intrusion porosimetry in accordance with the standard ASTM D 4284-83 (reapproved 2008) (“Standard method for determining pore volume distribution of catalysts by mercury intrusion porosimetry”).

It is possible to use a Micromeritics Autopore IV 9500 device provided with a powder penetrometer by conforming to the instructions recommended by the manufacturer.

Mercury intrusion porosimetry makes it possible to obtain the pore volume (V) as a function of the pore diameter (D). From these data, it is possible to obtain the curve (C) representing the derivative (dV/d log D) of the function V as a function of log D. The derived curve (C) can exhibit one or more peaks each located at a diameter denoted by Dp. The pores which are regarded as characteristics for the invention are those exhibiting a diameter of less than or equal to 200 nm.

For the mercury porosimetry technique, use may be made of a Micromeritrics Autopore IV 9500 machine equipped with a powder penetrometer in accordance with the instructions recommended by the manufacturer. The procedure of standard ASTM D 4284-83 (reapproved 2008) may be followed.

### EXAMPLES

### Example 1: Composition CeO₂ 40%-ZrO₂ 50%-La₂O₃ 5%-Y₂O₃ 5%

This example describes the preparation of a composition of cerium, zirconium, lanthanum and yttrium in respective proportions by weight of oxide of 40%, 50%, 5%, 5%.

A solution is prepared by mixing 48.55 liters of deionized water, 11.36 liters of a cerium nitrate solution ([Ce³⁺]=2.7 mol/L, density=1.707 kg/L) and 23.81 liters of a zirconium oxynitrate solution ([ZrO2]=277 g/L, density=1.442 kg/L). To this solution, 10.44 liters of a concentrated nitric acid solution ([HNO₃]=67 wt %, density=1.399 kg/L) and 10.50 liters of an aqueous hydrogen peroxide solution ([H₂O₂]=35 wt %, density=1.135 kg/L) are added. After this addition, the solution is agitated for 30 minutes.

In a precipitation tank equipped with a 4-blade impeller, 68.17 liters of an aqueous ammonia solution ([NH₃]=15.1 wt % and density=0.941 kg/L) and 41.83 liters of deionized water are charged.

The solution containing cerium and zirconium prepared above is then introduced in the precipitation tank in 60 minutes. The agitation speed during the precipitation is 220 rpm.

3.09 liters of an yttrium nitrate solution ([Y³⁺]=1.89 mol/L, density=1.411 kg/L) is then added to the precipitation tank with the same flow rate as the solution containing cerium and zirconium.

The temperature of the mixture is then increased to 60° C. 2.24 liters of a lanthanum nitrate solution ([La³⁺]=1.81 mol/L, density=1.473 kg/L) are then added to the precipitation tank with the same flow rate as the solution containing cerium and zirconium.

The mixture is then aged under stirring at 150° C. during 2 hours in an autoclave.

Then, the temperature is decreased to around 60° C. and 4.356 kg of lauric acid are introduced under stirring. The mixture is maintained under stirring for 1 hour.

The mixture is then filtered and the cake is washed with 60 liters of deionised water.

The obtained solid is calcined at 850° C. for 3 hours.

| | Thermal stability | | | Hg porosity | | | | |
|---|---|---|---|---|---|---|---|---|
| | SA | SA | SA | (900° C./ | Hg porosity | | | |
| | 120° C./ | 1000° C./ | 1100° C./ | 4 h) | (1100° C/4 h) | | | Tapped |
| | 3 h | 4 h | 4 h | Pore size | Pore size | | V2 | density |
| Composition | (m²/g) | (m²/g) | (m²/g) | (nm) | (nm) | V1/V2 | (ml/g) | (g/cm³) |
| CZLY = | 85 | 57 | 30.9 | 23 | 28 | 0.55 | 0..25 | 0.69 |
| 40/50/5/5 | | | | | | | | |

### Example 2—Composition CeO₂ 10%-ZrO₂ 72%-La₂O₃ 5%-Y₂O₃ 8%-Nd₂O₃ 5%

This example describes the preparation of a composition of cerium, zirconium, lanthanum, yttrium and neodymium in respective proportions by weight of oxide of 10%, 72%, 5%, 8%, 5%.

A solution is prepared by mixing 62.21 liters of deionized water, 2.6 liters of a cerium nitrate solution ([Ce³⁺]=2.7 mol/L, density=1.707 kg/L) and 31.38 liters of a zirconium oxynitrate solution ([ZrO₂]=277 g/L, density=1.442 kg/L). To this solution, 13.78 liters of a concentrated nitric acid solution ([HNO₃]=67 wt %, density=1.399 kg/L) and 2.41 liters of an aqueous hydrogen peroxide solution ([H₂O₂]=35 wt %, density=1.135 kg/L) are added. After this addition, the solution is agitated during 30 minutes.

In a precipitation tank equipped with a 4-blade impeller, 73.89 liters of an aqueous ammonia solution ([NH₃]=15.1 wt % and density=0.941 kg/L) and 47.11 liters of deionized water are charged.

The solution containing cerium and zirconium prepared above is then introduced in the precipitation tank in 60 minutes.

A solution is prepared by mixing 4.54 liters of an yttrium nitrate solution ([Y³⁺]=1.89 mol/L, density=1.411 kg/L) and 2.03 liters of a Neodymium nitrate solution ([Nd³⁺]=1.77 mol/L, density=1.474 kg/L). This solution is then added to the precipitation tank with the same flow rate as the solution containing cerium and zirconium.

The temperature of the mixture is then increased to 60° C.

2.05 liters of a lanthanum nitrate solution ([La3+]=1.81 mol/L, density=1.473 kg/L) are then added to the precipitation tank with the same flow rate as the solution containing cerium and zirconium.

The mixture is then aged under stirring at 150° C. during 2 hours in an autoclave.

Then, the temperature is decreased to around 60° C. and 3.993 kg of lauric acid are introduced under stirring. The mixture is maintained under stirring for 1 hour.

The mixture is then filtered and the cake is washed with 60 liters of deionised water.

The obtained solid is calcined at 1020° C. for 2 hours

| | Thermal stability | | | Hg porosity | | | | |
|---|---|---|---|---|---|---|---|---|
| | SA | SA | SA | (900° C./ | Hg porosity | | | |
| | 120° C./ | 1000° C./ | 1100° C./ | 4 h) | (1100° C./4 h) | | | Tapped |
| | 3 h | 4 h | 4 h | Pore size | Pore size | | V2 | density |
| Composition | (m²/g) | (m²/g) | (m²/g) | (nm) | (nm) | V1/V2 | (ml/g) | (g/cm³) |
| CZLNY = | 53 | 51.4 | 33.4 | 30 | 36 | 0.58 | 0.41 | 0.75 |
| 10/72/5/5/8 | | | | | | | | |

### Example 3—Composition CeO₂ 24%-ZrO₂ 60%-La₂O₃ 3.5%-Y₂O₃ 12.5%

This example describes the preparation of a composition of cerium, zirconium, lanthanum and yttrium in respective proportions by weight of oxide of 24%, 60%, 3.5%, 12.5%.

A solution is prepared by mixing 61.81 liters of deionized water, 6.25 liters of a cerium nitrate solution ([Ce³⁺]=2.7 mol/L, density=1.707 kg/L) and 26.15 liters of a zirconium oxynitrate solution ([ZrO₂]=277 g/L, density=1.442 kg/L). To this solution, 11.48 liters of a concentrated nitric acid solution ([HNO₃]=67 wt %, density=1.399 kg/L) and 5.79 liters of an aqueous hydrogen peroxide solution ([H₂O₂]=35 wt %, density=1.135 kg/L) are added. After this addition, the solution is agitated for 30 minutes.

In a precipitation tank equipped with a 4-blade impeller, 68.81 liters of an aqueous ammonia solution ([NH₃]=15.1 wt % and density=0.941 kg/L) and 52.19 liters of deionized water are charged.

The solution containing cerium and zirconium prepared above is then introduced in the precipitation tank in 60 minutes.

7.09 liters of an yttrium nitrate solution ([Y³⁺]=1.89 mol/L, density=1.411 kg/L) is then added to the precipitation tank with the same flow rate as the solution containing cerium and zirconium.

The temperature of the mixture is then increased to 60° C.

1.44 liters of a lanthanum nitrate solution ([La³⁺]=1.81 mol/L, density=1.473 kg/L) are then added to the precipitation tank with the same flow rate as the solution containing cerium and zirconium.

The mixture is then aged under stirring at 150° C. during 2 hours in an autoclave.

Then, the temperature is decreased to around 60° C. and 3.993 kg of lauric acid are introduced under stirring. The mixture is maintained under stirring for 1 hour.

The mixture is then filtered and the cake is washed with 60 liters of deionised water.

The obtained solid is calcined at 850° C. for 3 hours.

| | Thermal stability | | | Hg porosity | | | | |
|---|---|---|---|---|---|---|---|---|
| | SA | SA | SA | (900° C/ | Hg porosity | | | |
| | 120° C./ | 1000° C./ | 1100° C./ | 4 h) | (1100° C/4 h) | | | Tapped |
| | 3 h | 4 h | 4 h | Pore size | Pore size | | V2 | density |
| Composition | (m²/g) | (m²/g) | (m²/g) | (nm) | (nm) | V1/V2 | (ml/g) | (g/cm³) |
| CeZrLaY = | 86 | 62.1 | 34.8 | 19 | 30 | 0.57 | 0.34 | 0.59 |
| 24/60/3.5/12.5 | | | | | | | | |

### Comparative Example 1—Composition CeO₂ 40%-ZrO₂ 50%-La₂O₃ 5%-Y₂O₃ 5%

This example describes the preparation of a composition of cerium, zirconium, lanthanum, yttrium in respective proportions by weight of oxide of 40%, 50%, 5%, 5%.

A solution is prepared by mixing 63.4 liters of deionized water, 11.36 liters of a cerium nitrate solution ([Ce³⁺]=2.7 mol/L, density=1.707 kg/L) and 23.77 liters of a zirconium oxynitrate solution ([ZrO₂]=277 g/L, density=1.442 kg/L). To this solution 2.88 liters of a concentrated nitric acid solution ([HNO₃]=67 wt %, density=1.399 kg/L) is added. Then 3.09 liters of an yttrium nitrate solution ([Y³⁺]=1.89 mol/L, density=1.411 kg/L) and 2.24 liters of a lanthanum nitrate solution ([La³⁺]=1.81 mol/L, density=1.473 kg/L) are added. Finally 3.29 liters of an aqueous hydrogen peroxide solution ([H₂O₂]=35 wt %, density=1.135 kg/L) are added. After this addition, the solution is agitated for 30 minutes.

In a precipitation tank equipped with a 4-blade impeller, 48.48 liters of an aqueous ammonia solution ([NH₃]=15.1 wt % and density=0.941 kg/L) and 61.52 liters of deionized water are charged.

The solution containing cerium, zirconium, yttrium and lanthanum prepared above is then introduced into the precipitation tank in 60 minutes.

The temperature of the mixture is then increased to 95° C.

The mixture is then aged under stirring at 120° C. during 2 hours in an autoclave.

Then, the temperature is decreased to around 60° C. and 4.356 kg of lauric acid are introduced under stirring. The mixture is maintained under stirring for 1 hour.

The mixture is then filtered and the cake is washed with 60 liters of deionised water.

The obtained solid is calcined at 850° C. for 3 hours.

| | Thermal stability | | | Hg porosity | | | | |
|---|---|---|---|---|---|---|---|---|
| | SA | SA | SA | (900° C/ | Hg porosity | | | |
| | 120° C./ | 1000° C./ | 1100° C./ | 4 h) | (1100° C/4 h) | | | Tapped |
| | 3 h | 4 h | 4 h | Pore size | Pore size | | V2 | density |
| Composition | (m²/g) | (m²/g) | (m²/g) | (nm) | (nm) | V1/V2 | (ml/g) | (g/cm³) |
| CZLY = | 80 | 47.1 | 26.3 | 30 | 36 | 0.54 | 0.24 | 0.7 |
| 40/50/5/5 | | | | | | | | |

### Comparative Example 2—Composition CeO₂ 40%-ZrO₂ 50%-La₂O₃ 5%-Y₂O₃ 5%

This example describes the preparation of a composition of cerium, zirconium, lanthanum, yttrium in respective proportions by weight of oxide of 40%, 50%, 5%, 5% according to the process described in WO 2017/187085.

A solution of cerium nitrate and zirconium nitrate is prepared by introducing, into a vessel, 95.43 liters of water, 11.3 liters of an aqueous zirconium nitrate solution ([ZrO2]=266 g/l; density=1.408 kg/l) and also 5.8 liters of an aqueous ceric nitrate solution ([CeO2]=259 g/l; density=1.439 kg/l). An aqueous solution of lanthanum nitrate and yttrium nitrate is also prepared by introducing, into another vessel, 10.77 liters of water, 0.53 liter of a lanthanum nitrate solution ([La2O3]=472.5 g/l; density=1.711 kg/1) and 1.2 liters of an yttrium nitrate solution ([Y2O3]=208.5 g/l; density=1.391 kg/1).

An ammonia solution (121 at 12 mol/l) is introduced with stirring into a reactor of approximately 250 liters equipped with a stirrer having inclined blades and the solution is subsequently made up with distilled water so as to obtain a total volume of 125 liters of basic aqueous solution. This makes it possible to provide a stoichiometric excess of ammonia of 40 molar %, with respect to the cations which are present in the two solutions described above.

The two solutions prepared above are kept continually stirred. The solution of cerium nitrate and zirconium nitrate is introduced over 45 min into the stirred reactor which contains the ammonia solution, the stirring of which is adjusted to a rate of 200 rpm (80 Hz). The solution of lanthanum nitrate and yttrium nitrate is then introduced over 15 min into the stirred reactor, the stirring of which is this time adjusted to 25 rpm (10 Hz). A mixture is obtained.

The mixture is poured into a stainless steel autoclave equipped with a stirrer. The mixture is heated with stirring at 150° C. for 2 h. It is then left to cool down to a temperature of less than 60° C. and 1.65 kg of lauric acid are added to the mixture. The mixture is kept stirred for 1 h.

The mixture is then filtered and then the precipitate is washed with aqueous ammonia solution of pH=9.5 in a proportion of one times the volume of the filtration mother liquors (washing is carried out with 250 liters of aqueous ammonia solution). The solid product obtained is subsequently calcined under air at 950° C. for 3 h in order to recover approximately 5 kg of mixed oxide. The obtained solid is calcined at 825° C. for 3 hours.

| | Thermal stability | | | Hg porosity | | | |
|---|---|---|---|---|---|---|---|
| | SA | SA | SA | (900° C/ | Hg porosity | | |
| | 120° C./ | 1000° C./ | 1100° C./ | 4 h) | (1100° C/4 h) | | |
| | 3 h | 4 h | 4 h | Pore size | Pore size | | V2 |
| Composition | (m²/g) | (m²/g) | (m²/g) | (nm) | (nm) | V1/V2 | (ml/g) |
| CZLY = | 87 | 61 | 31 | 18 | 28 | 0.9 | 0.19 |
| 40/50/5/5 | | | | | | | |

1. A mixed oxide of zirconium, cerium, lanthanum and optionally of at least one rare earth metal other (REM) than cerium and lanthanum, the proportions by weight of these elements, expressed as oxide equivalent, with respect to the total weight of the mixed oxide being as follows:
between 8% and 47% of cerium;
between 1% and 10% of lanthanum;
between 0% and 15% of the rare earth metal other than cerium and lanthanum;
the remainder as zirconium,
wherein the mixed oxide exhibits:
after calcination at a temperature of 1100° C. for 4 hours, a BET specific surface area of at least 30 m²/g;
after calcination at a temperature of 1000° C. for 4 hours, a BET specific surface area of at least 50 m²/g;
a derivative curve (dV/d log D) obtained by mercury porosimetry on the mixed oxide after calcination at a temperature of 1100° C. for 4 hours exhibits, in the range of the pores with a diameter of less than or equal to 200 nm, one peak for which the maximum corresponds to a pore diameter, denoted Dp,1100° C./4 h, of between 25 and 40 nm, preferably between 25 and 38 nm, V and D respectively denoting the pore volume and the pore diameter, and
a ratio R defined by:
$$R = V 1 / V 2$$
wherein:
V1 is the pore volume developed by the pores for which the diameter in nm is between (Dp,1100° C./4 h−15) and (Dp,1100° C./4 h+15);
V2 is the pore volume developed by the pores for which the diameter is less than or equal to 200 nm;
V1 and V2 being determined by mercury porosimetry on the mixed oxide after calcination at 1100° C. for 4 h; and
wherein R is comprised between 0.50 and 0.60.

2. The mixed oxide as claimed claim 1, further comprising hafnium.

3. The mixed oxide as claimed in claim 2, wherein the proportion by weight of hafnium in the mixed oxide is less than or equal to 2.5%, indeed even less than or equal to 2.0%, expressed as oxide equivalent with respect to the total weight of the mixed oxide.

4. The mixed oxide as claimed in claim 1, wherein the elements Ce, La, REM other than cerium and lanthanum, Zr and Hf are present in the form of oxide, of hydroxide or of oxyhydroxide, more particularly in the form of oxide.

5. The mixed oxide as claimed in claim 1, wherein the REM other than cerium and lanthanum is chosen from yttrium, neodymium or praseodymium or any combination thereof.

6. The mixed oxide as claimed in claim 1, comprising only yttrium as REM other than cerium and lanthanum.

7. The mixed oxide as claimed in claim 1, comprising only two REM other than cerium and lanthanum, which may be yttrium and neodymium or yttrium and praseodymium.

8. The mixed oxide as claimed in claim 1, a comprising a mixture of oxides of zirconium, of cerium, of lanthanum, optionally of at least one REM other than cerium and lanthanum and optionally of hafnium.

9. The mixed oxide as claimed in claim 1, not comprising any rare earth metal other than cerium and lanthanum.

10. The mixed oxide as claimed in claim 1, consisting essentially of the following elements:
zirconium, cerium, lanthanum, yttrium and optionally hafnium;
zirconium cerium, lanthanum, yttrium, neodymium and optionally hafnium; or
zirconium cerium, lanthanum, yttrium, praseodymium and optionally hafnium;
zirconium cerium, lanthanum, neodymium, praseodymium and optionally hafnium; or
zirconium cerium, lanthanum and optionally hafnium.

11. The mixed oxide as claimed in claim 1, wherein the proportion by weight of the zirconium, expressed as oxide equivalent, may be between 40.0% and 91.0%, preferably between 44.0 and 80.0%, more preferably between 44.0 and 76.0%.

12. The mixed oxide of claim 1, wherein the tapped density of the mixed oxide is equal to or greater than 0.4 g/cm³, equal to or greater than 0.5 g/cm³, or from 0.5 g/cm³ to 0.9 g/cm³.

13. (canceled)

14. The mixed oxide as claimed in claim 12, wherein the derivative curve (dV/d log D) obtained by mercury porosimetry on the mixed oxide after calcination at a temperature of 900° C. for 4 hours exhibits, in the range of the pores with a diameter of less than or equal to 200 nm, one peak for which the maximum corresponds to a pore diameter denoted Dp,900° C./4 h and such that the difference in absolute value (Dp,1100° C./4 h)−(Dp, 900° C./4 h) is less than or equal to 15 nm, preferably less than or equal to 12, indeed even less than or equal to 11 nm.

15. The mixed oxide as claimed in claim 12, characterized by a pore volume V2 of 0.20 to 0.50 ml/g, in particular of 0.24 to 0.41 ml/g.

16. The mixed oxide as claimed in claim 12, which is provided in the form of a powder, the mean diameter d50 of which, determined by laser diffraction over a distribution by volume, is comprised between 1.0 and 30.0 m preferably between 2.0 and 20.0 m even more preferably between 3.0 and 10.0 m.

17. The mixed oxide as claimed in claim 12, wherein the derivative curve (dV/d log D), obtained by mercury porosimetry on the mixed oxide after calcination at a temperature of 900° C. for 4 hours, does not exhibit two distinct peaks.

18. A process for the preparation of the mixed oxide as claimed in claim 1, comprising the following steps:
(a1) an aqueous solution of cerium nitrate and of zirconium nitrate is introduced into a stirred vessel containing a basic aqueous solution;
(a2) optionally an aqueous solution of nitrate of the rare earth metal other than cerium and lanthanum is subsequently introduced into the mixture formed in step (a1), and kept stirred;
(a2′) optionally the mixture obtained at the end of step (a1) or (a2) is heated at a temperature comprised between 5° and 95° C.;
(a3) an aqueous solution of lanthanum nitrate is subsequently introduced into the mixture formed in step (a2′), (a2) or (a1), and kept stirred
(a4) the mixture obtained at the end of step (a3) is heated with stirring;
(a5) a templating agent is subsequently introduced into the mixture obtained in the preceding step;
(a6) optionally, the mixture is filtered and the precipitate is washed;
(a7) the precipitate obtained at the end of step (a6) is calcined at a temperature of between 700° C. and 1100° C.; and
(a8) the mixed oxide obtained in step (a7) is optionally ground.

19. The process according to claim 18, wherein the concentration of mixed oxide of the aqueous solution after step (a3) is from 30 g/l to 80 g/l expressed as metal oxides.

20. (canceled)

21. A composition comprising the mixed oxide as claimed in claim 1 as a mixture with at least one mineral material.

22. The composition as claimed in claim 21, in wherein the mineral material is chosen from alumina, titanium oxide, cerium oxide, zirconium oxide, silica, spinels, zeolites, silicates, crystalline silicoaluminum phosphates or crystalline aluminum phosphates.

23. A catalytically active coating layer, deposited at the surface area of a solid support, comprising the mixed oxide of claim 1.

24. (canceled)

25. (canceled)

26. A process for the treatment of exhaust gases from internal combustion engines, wherein use is made of a catalytic converter comprising a catalytically active coating layer as claimed in claim 23.
